(19) United States
(12) Patent Application Publication
(10) Pub. No.: US 2006/0142993 A1
(43) Pub. Date: Jun. 29, 2006

(54) System and method for utilizing distance measures to perform text classification

(75) Inventors: Xavier Menendez-Pidal, Los Gatos, CA (US); Lei Duan, San Jose, CA (US); Michael W. Emonts, Marina, CA (US)

Correspondence Address: Gregory J. Koerner;REDWOOD PATENT LAW, Suite 205, 1291 East Hillsdale Boulevard, Foster City, CA, 94404, US

(73) Assignees: Sony Corporation; Sony Electronics Inc.

(21) Appl. No.: 11/024,095

(22) Filed: Dec. 28, 2004

(51) Int. Cl. G06F 17/27

(52) U.S. Cl. 704/9

(57) ABSTRACT

A system and method for utilizing distance measures to perform text classification includes text classification categories that each have reference models of reference N-grams. Input text that includes input N-grams is accessed for performing the text classification. A text classifier calculates distance measures between the input N-grams and the reference N-grams. The text classifier then utilizes the distance measures to identify a matching category for the input text. In certain embodiments, a verification module performs a verification procedure to determine whether the initially-selected matching category is a valid classification result for the text classification.

### BACKGROUND SECTION

1. Field of Invention

This invention relates generally to electronic text classification systems, and relates more particularly to a system and method for utilizing distance measures to perform text classification.

2. Background

Implementing effective methods for handling electronic information is a significant consideration for designers and manufacturers of contemporary electronic devices. However, effectively handling information with electronic devices may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced device capability to perform various advanced operations may provide additional benefits to a system user, but may also place increased demands on the control and management of various device components. For example, an enhanced electronic device that effectively handles and classifies various types of text data may benefit from an effective implementation because of the large amount and complexity of the data involved.

Due to growing demands on system resources and substantially increasing data magnitudes, it is apparent that developing new techniques for handling electronic information is a matter of concern for related electronic technologies. Therefore, for all the foregoing reasons, developing effective systems for handling information remains a significant consideration for designers, manufacturers, and users of contemporary electronic devices.

### SUMMARY

In accordance with the present invention, a system and method are disclosed for utilizing distance measures to perform text classification. In one embodiment, a text classifier of an electronic device initially accesses reference databases of reference models. Each reference database corresponds to a different text classification category. In certain embodiments, the reference models are configured as reference N-grams of “N” sequential words. The text classifier then calculates reference statistics corresponding to the reference models. In certain embodiments, the reference statistics represent the frequency of corresponding reference models in an associated reference database.

The text classifier also accesses input text for classification. In certain embodiments, the input text includes input N-grams of “N” sequential words. The text classifier calculates input statistics corresponding to the input N-grams from the input text. In certain embodiments, the input statistics represent the frequency of corresponding input N-grams in the input text. In accordance with the present invention, the text classifier next calculates distance measures representing correlation characteristics between the input N-grams and each of the reference models.

In one embodiment, the text classifier calculates the distance measures by comparing the previously-calculated input statistics and reference statistics. Finally, the text classifier generates an N-best list of classification candidates corresponding to the most similar pairs of input N-grams and reference models. In accordance with the present invention, the top classification candidate with the best distance measure indicates an initial text classification result for the corresponding input text. The text classification category corresponds to the reference model associated with the top classification candidate.

In certain embodiments, a verification module then performs a verification procedure to confirm or reject the initial text classification result. A verification threshold value “T” is initially defined in any effective manner. The verification module then accesses the distance measures corresponding to classification candidates from the N-best list. The verification manager utilizes the distance measures to calculate a verification measure “V”.

The verification module then determines whether the verification measure “V” is less than the defined verification threshold value “T”. If the verification measure “V” is less than the verification threshold value “T”, then the verification module indicates that the top candidate of the N-best list should be in a first categorization category in order to become a verified classification result. Conversely, if the verification measure “V” is greater than or equal to the verification threshold value “T”, then the verification module indicates that the top candidate of the N-best list should be in a second classification category II in order to become a verified classification result. For at least the foregoing reasons, the present invention therefore provides an improved system and method for utilizing distance measures to perform text classification.

### BRIEF DESCRIPTION OF THE DRAWINGS

FIG. 1 is a block diagram for one embodiment of an electronic device, in accordance with the present invention;

FIG. 2 is a block diagram for one embodiment of the memory of FIG. 1, in accordance with the present invention;

FIG. 3 is a block diagram for one embodiment of the reference models of FIG. 2, in accordance with the present invention;

FIG. 4 is a diagram of an N-best list, in accordance with one embodiment of the present invention;

FIG. 5 is a block diagram for utilizing distance measures to perform text classification, in accordance with one embodiment of the present invention;

FIG. 6 is a flowchart of method steps for performing a text classification procedure, in accordance with one embodiment of the present invention; and

FIG. 7 is a flowchart of method steps for performing a verification procedure, in accordance with one embodiment of the present invention.

### DETAILED DESCRIPTION

The present invention relates to an improvement in electronic text classification systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for utilizing distance measures to perform text classification, and includes text classification categories that each have reference models of reference N-grams. Input text that includes input N-grams is accessed for performing the text classification. A text classifier calculates distance measures between the input N-grams and the reference N-grams. The text classifier then utilizes the distance measures to identify a matching category for the input text. In certain embodiments, a verification module performs a verification procedure to determine whether the initially-selected matching category is a valid classification result for the text classification.

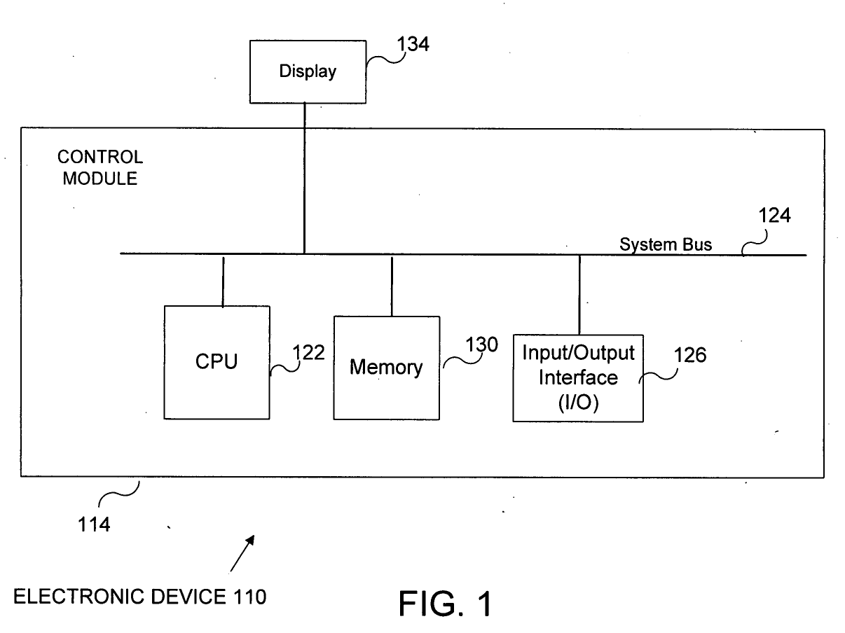

Referring now to FIG. 1, a block diagram for one embodiment of an electronic device 110 is shown, according to the present invention. The FIG. 1 embodiment includes, but is not limited to, a control module 114 and a display 134. In alternate embodiments, electronic device 110 may readily include various other elements or functionalities in addition to, or instead of, certain elements or functionalities discussed in conjunction with the FIG. 1 embodiment.

In accordance with certain embodiments of the present invention, electronic device 110 may be embodied as any appropriate electronic device or system. For example, in certain embodiments, electronic device 110 may be implemented as a computer device, a personal digital assistant (PDA), a cellular telephone, a television, or a game console. In the FIG. 1 embodiment, control module 114 includes, but is not limited to, a central processing unit (CPU) 122, a memory 130, and one or more input/output interface(s) (I/O) 126. Display 134, CPU 122, memory 130, and I/O 126 are each coupled to, and communicate, via common system bus 124. In alternate embodiments, control module 114 may readily include various other components in addition to, or instead of, certain of those components discussed in conjunction with the FIG. 1 embodiment.

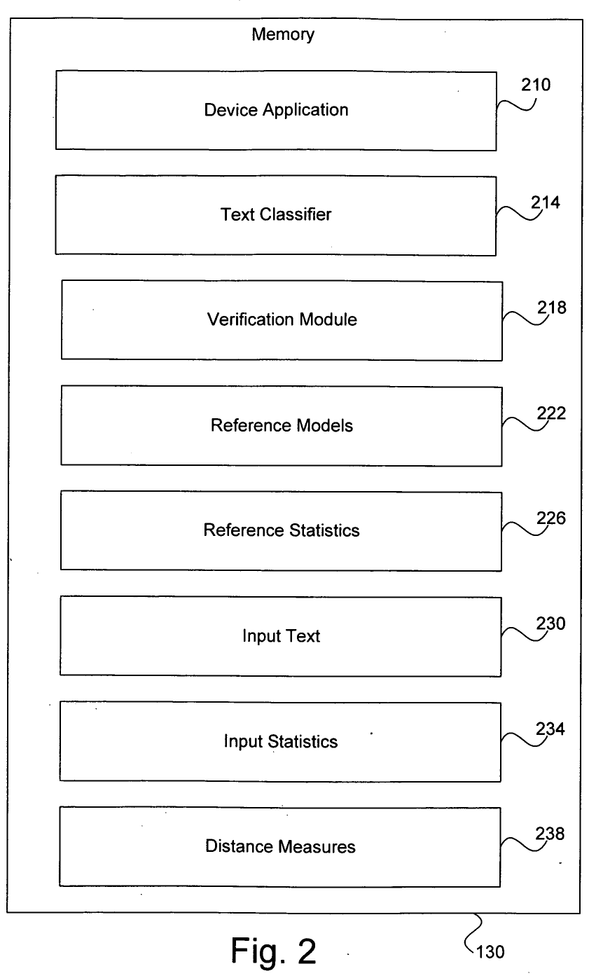

In the FIG. 1 embodiment, CPU 122 is implemented to include any appropriate microprocessor device. Alternately, CPU 122 may be implemented using any other appropriate technology. For example, CPU 122 may be implemented as an application-specific integrated circuit (ASIC) or other appropriate electronic device. In the FIG. 1 embodiment, I/O 126 provides one or more interfaces for facilitating bi-directional communications between electronic device 110 and any external entity, including a system user or another electronic device. I/O 126 may be implemented using any appropriate input and/or output devices. The functionality and utilization of electronic device 110 are further discussed below in conjunction with FIGS. 2-7.

Referring now to FIG. 2, a block diagram for one embodiment of the FIG. 1 memory 130 is shown, according to the present invention. Memory 130 may comprise any desired storage-device configurations, including, but not limited to, random access memory (RAM), read-only memory (ROM), and storage devices such as floppy discs or hard disc drives. In the FIG. 2 embodiment, memory 130 stores a device application 210, a text classifier 214, a verification module 218, reference models 222, reference statistics 226, input text 230, input statistics 234, and distance measures 238. In alternate embodiments, memory 130 may readily store other elements or functionalities in addition to, or instead of, certain elements or functionalities discussed in conjunction with the FIG. 2 embodiment.

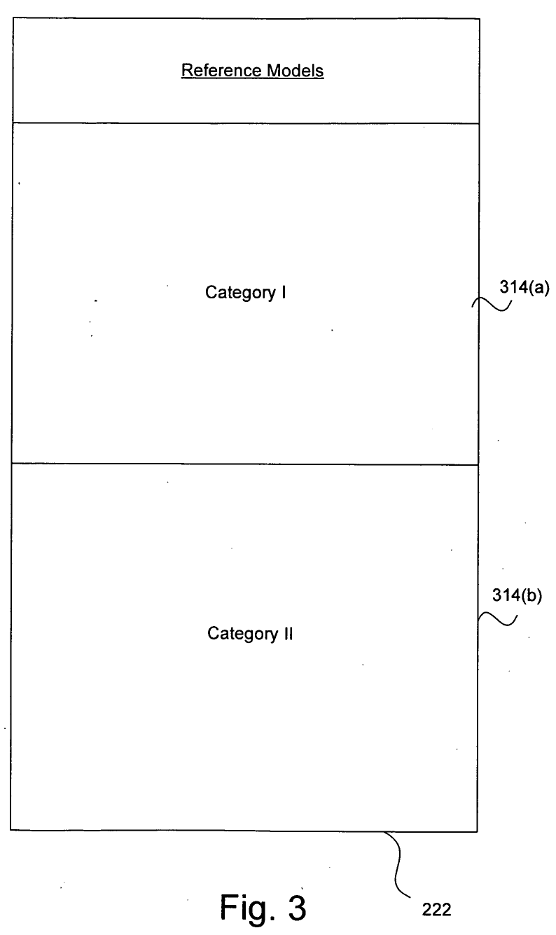

In the FIG. 2 embodiment, device application 210 includes program instructions that are executed by CPU 122 (FIG. 1) to perform various functions and operations for electronic device 110. The particular nature and functionality of device application 210 varies depending upon factors such as the type and particular use of the corresponding electronic device 110. In the FIG. 2 embodiment, text classifier 214 includes one or more software modules that are executed by CPU 122 to analyze and classify input text into two or more classification categories. Certain embodiments for utilizing text classifier 214 are further discussed below in conjunction with FIGS. 3-6.

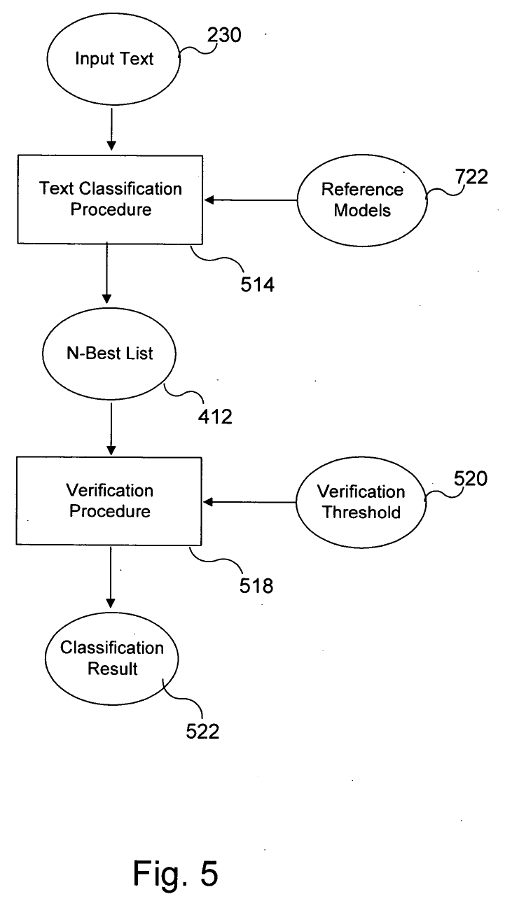

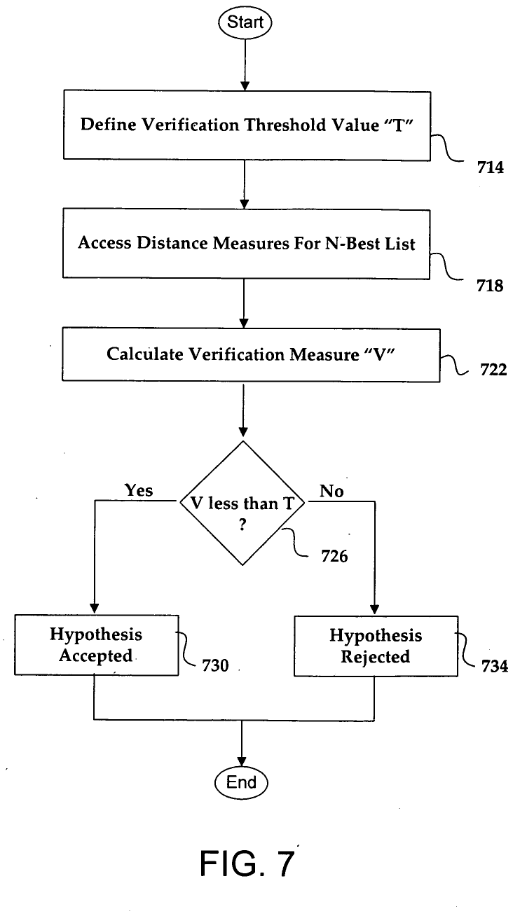

In the FIG. 2 embodiment, verification module 218 performs a verification procedure to verify results of a text classification procedure. One embodiment for utilizing verification module is further discussed below in conjunction with FIGS. 5 and 7. In the FIG. 2 embodiment, text classifier 214 analyzes reference models 222 to calculate corresponding reference statistics 226. One embodiment of reference models 222 is further discussed below in conjunction with FIG. 3. In the FIG. 2 embodiment, text classifier 214 also analyzes input text 230 to calculate corresponding input statistics 234. Input text 230 may include any type of text data in any appropriate format.

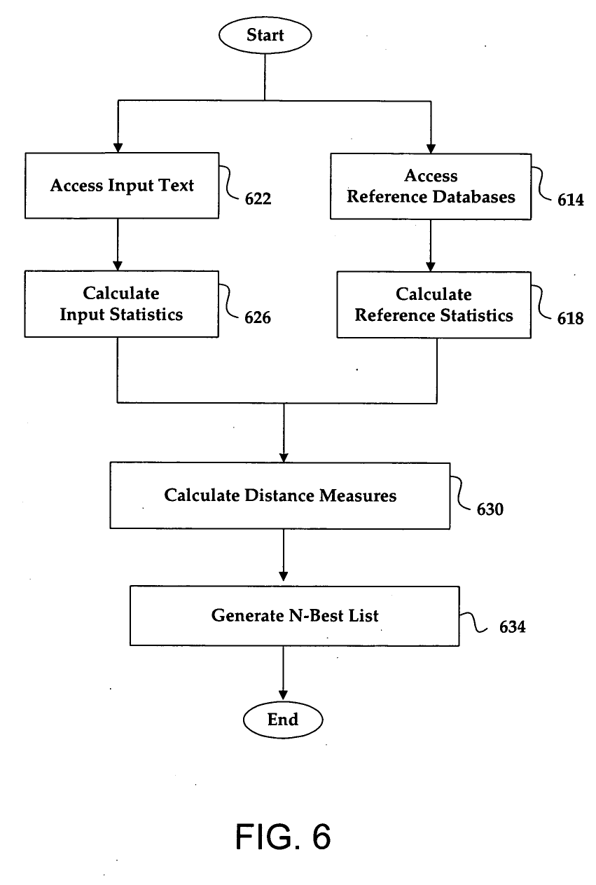

In the FIG. 2 embodiment, text classifier 214 calculates distance measures 238 by comparing input statistics 234 with reference statistics 226. Each one of the calculated distance measures 238 quantifies the degree of correlation or cross entropy between a given input statistic 234 and a given reference statistic 226. The calculation and utilization of distance measures 238 is further discussed below in conjunction with FIGS. 5-6.

Referring now to FIG. 3, a block diagram for one embodiment of the FIG. 2 reference models 222 is shown, in accordance with the present invention. In the FIG. 3 embodiment, for purposes of illustration, reference models 222 are grouped into a category I 314(a) and a category II 314(b). In alternate embodiments, reference models 222 may readily include various other elements or configurations in addition to, or instead of, certain elements or configurations discussed in conjunction with the FIG. 3 embodiment. For example, in alternate embodiments, reference models 222 may be grouped into any desired number of different categories 314 that each correspond to a different text classification subject. For example, category 314(a) may correspond to spontaneous speech and category II 314(b) may correspond to non-spontaneous speech.

In the FIG. 3 embodiment, text classifier 214 (FIG. 2) analyzes reference text databases to locate all instances of reference models 222. In accordance with the present invention, reference models 222 are each implemented as an N-gram that includes “N” consecutive words in a given sequence. For example, reference models 222 may be implemented as unigrams (one word), bi-grams (two words), or tri-grams (three words), or N-grams of any other length.

In the FIG. 3 embodiment, reference models 222 of category I 314(a) may be derived from a first reference text database of text data that represents or pertains to category I 314(a). Similarly, reference models 222 of category II 314(b) may be derived from a second reference text database of text data that represents or pertains to category II 314(b). In the FIG. 3 embodiment, the total number of categories 314 is equal to the number of different text classification categories supported by text classifier 214 (FIG. 2). The implementation and utilization of reference models 222 are further discussed below in conjunction with FIGS. 5-6.

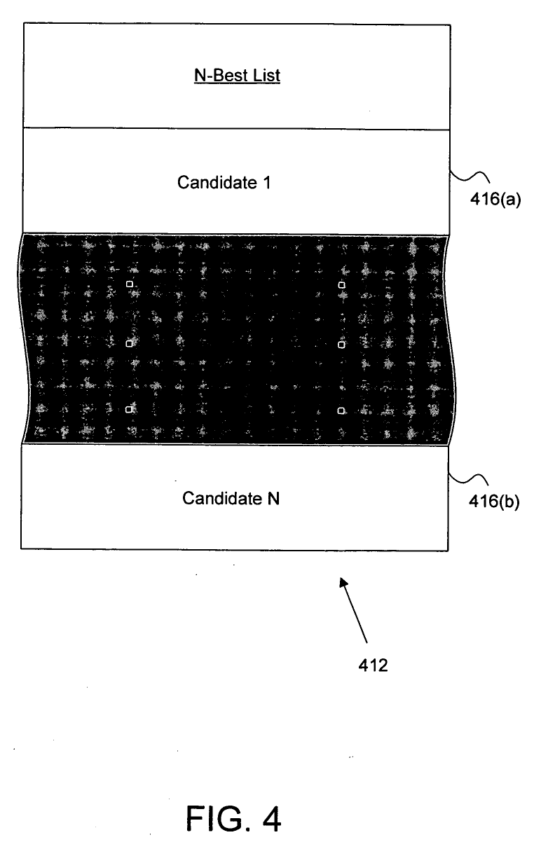

Referring now to FIG. 4, a diagram of an N-best list 412 is shown, in accordance with one embodiment of the present invention. In alternate embodiments, the present invention may utilize N-best lists with various elements or configurations in addition to, or instead of, certain elements or configurations discussed in conjunction with the FIG. 4 embodiment.

In the FIG. 4 embodiment, N-best list 412 includes a candidate 1 (416(a)) through a candidate N 416(b). In the FIG. 4 embodiment, N-best list 412 has a total number of candidates 416 equal to the number of different text classification categories supported by text classifier 214. In the FIG. 4 embodiment, each candidate 416 is ranked according to a corresponding distance measure 238 (FIG. 2) that quantifies how closely a given input N-gram of input text 230 (FIG. 2) correlates to a particular reference model 222 (FIG. 3). In the FIG. 4 embodiment, the top candidate 416(a) with the best distance measure 238 indicates an initial text classification result for the corresponding input text 230. Calculation and utilization of N-best list 412 are further discussed below in conjunction with FIGS. 5-7.

Referring now to FIG. 5, a block diagram for utilizing distance measures 238 (FIG. 2) to perform text classification is shown, in accordance with one embodiment of the present invention. In alternate embodiments, the present invention may perform text classification with various elements or techniques in addition to, or instead of, certain of the elements or techniques discussed in conjunction with the FIG. 5 embodiment.

In the FIG. 5 embodiment, text classifier 214 (FIG. 2) begins a text classification procedure 514 by calculating input statistics 234 (FIG. 2) that each correspond to a different input text segment from input text 230. In accordance with the present invention, the input text segments are each implemented as an N-gram that includes “N” consecutive words in a given sequence. For example, the input text segments may be implemented as unigrams (one word), bi-grams (two words), or tri-grams (three words), or N-grams of any other length. Similarly, text classifier 214 also calculates reference statistics 226 (FIG. 2) that each correspond to a different reference model 222 (FIG. 3) from various reference text categories 314 (FIG. 3).

In the FIG. 5 embodiment, input statistics 234 and reference statistics 226 are both calculated by observing the frequency of a given N-gram in relation to the total number of N-grams in either input text 230 or reference models 222. In the FIG. 5 embodiment, input statistics 234 and reference statistics 226 are expressed by the following three formulas for unigram, bi-gram, and tri-gram probabilities:

$$P ( {w}_{i} ) = \frac{C ( {w}_{i} )}{{\sum }_{{w}_{i}} C ( {w}_{i} )} , \\ P ( {w}_{i} \vert {w}_{i - 1} ) = \frac{C ( {w}_{i - 1} {w}_{i} )}{{\sum }_{{w}_{i}} C ( {w}_{i - 1} {w}_{i} )} , \\ P ( {w}_{i} \vert {w}_{i - 2} {w}_{i - 1} ) = \frac{C ( {w}_{i - 2} {w}_{i - 1} {w}_{i} )}{{\sum }_{{w}_{i}} C ( {w}_{i - 2} {w}_{i - 1} {w}_{i} )}$$

where P(wᵢ) is the frequency of single word unigrams, P(wi|wi-1) is the frequency of word-pair bi-grams, P(wᵢ|wᵢ₋₂ wᵢ₋₁) is the frequency of three-word tri-grams, and C(wᵢ) is the observation frequency of a word wᵢ (how many times the word wi appears in input text 230 or reference models 222.

After calculating input statistics 234 and reference statistics 226, text classifier 214 then calculates distance measures 238 (FIG. 2) for each input N-gram from input text 230 with reference to each of the reference models 222 from the text classification categories 314 (FIG. 3). In the FIG. 5 embodiment, text classifier 214 calculates each distance measure 238 by comparing an input statistic 234 (FIG. 2) for an input N-gram and a reference statistic 226 for a given reference model 222.

In the FIG. 5 embodiment, text classifier 214 calculates distance measures 238 according to the following formula:

$$D ( inp , tar ) = {\sum }_{Seq ( {w}_{i} ) ∈ input} ( {F}_{tar} ( {w}_{i} ) ln ( \frac{{F}_{tar} ( {w}_{i} )}{{F}_{inp} ( {w}_{i} )} ) + ( 1 - {F}_{tar} ( {w}_{i} ) ) ln ( \frac{1 - {F}_{tar} ( {w}_{i} )}{1 - {F}_{inp} ( {w}_{i} )} ) )$$

where D(inp, tar) is the distance measure 238 between an input N-Gram from input text (inp) 230 and a reference model (tar) 222, and F(wᵢ) is the unigram, bi-gram or tri-gram probability statistics: F(wᵢ)=P(wᵢ), P(wᵢ|wᵢ₋₁), or P(wᵢ|wᵢ₋₂,wᵢ₋₁), estimated from input text 230 (Fᵢₙₚ(wᵢ)) or from reference models 222 (Fₜₐᵣ(wᵢ)). Furthermore, if bi-grams or tri-grams are used in the text classification procedure, Seq(wᵢ) represents the existing list of sequences of the words pairs (for bi-grams) and word triplets (for tri-grams) that appears in input text 230. If unigrams are used in the text classification procedure, Seq(wᵢ) represents the list of individual words existing in input text 230.

In the FIG. 5 embodiment, after distance measures 238 have been calculated, text classifier 214 then generates an N-best list 412 that ranks pairs of input N-grams and reference N-grams according to their respective distance measures 238. In the FIG. 5 embodiment, verification module 218 (FIG. 2) then utilizes a predetermined verification threshold value to perform a verification procedure 518 to produce a verified classification result 522.

In the FIG. 5 embodiment, verification module 218 accesses N-best list 412 and calculates a verification measure based upon distance measures 238 for the candidates 416 (FIG. 4). For an example with two text classification categories 314 and two corresponding candidates 416 on N-best list 412, the verification measure “V” is calculated according to the following formula:
V=Distance A/Distance B
where Distance A is the distance measure 238 for the top candidate 416(a) from N-best list 412, and Distance B is the distance measure 238 for the second candidate 416(b) from N-best list 412. In cases where there are more than two candidates 416 on N-best list 412, Distance B is equal to the average of distance measures 238 excluding the top candidate 416(a).

In the FIG. 5 embodiment, verification module 218 then compares the verification measure to the verification threshold value 520. If the verification measure is less than the verification threshold value 520, then to become a verified classification result 522, the top candidate 416(a) of N-best list 412 which is associated with either category I 314(a) or category II 314(b) is accepted and the text can be correctly classified. Conversely, if the verification measure is greater than or equal to the verification threshold value 520, then to become a verified classification result 522, the matching category I 310(a) or category II 310(b) of the top candidate 416(a) of N-best list 412 is rejected and the text is not classified. For at least the foregoing reasons, the present invention therefore provides an improved system and method for utilizing distance measures to perform text classification.

Referring now to FIG. 6, a flowchart of method steps for performing a text classification procedure is shown, in accordance with one embodiment of the present invention. The FIG. 6 flowchart is presented for purposes of illustration, and in alternate embodiments, the present invention may readily utilize steps and sequences other than certain of those steps and sequences discussed in conjunction with the FIG. 6 embodiment.

In the FIG. 6 embodiment, in step 614, text classifier 214 initially accesses reference databases of reference models 222. In step 618, text classifier 214 then calculates reference statistics 226 corresponding to the reference models 222. Concurrently, in step 622, text classifier 214 accesses input text 230 for classification. In step 626, text classifier 214 calculates input statistics 226 corresponding to input N-grams from the input text 230.

In step 630, text classifier 214 next calculates distance measures 238 representing the correlation or cross entropy between the input N-grams from input text 230 and each of the reference models 222. In the FIG. 6 embodiment, text classifier 214 calculates distance measures 238 by comparing the previously-calculated input statistics 234 and reference statistics 226. Finally, in step 634, text classifier 214 generates an N-best list 412 of classification candidates 416 corresponding to the most similar pairs of input N-grams and reference models 222. In accordance with the present invention, the top candidate 416 with the best distance measure 238 indicates an initial text classification result for the corresponding input text 230. The FIG. 6 process may then terminate.

Referring now to FIG. 7, a flowchart of method steps for performing a verification procedure is shown, in accordance with one embodiment of the present invention. The FIG. 7 flowchart is presented for purposes of illustration, and in alternate embodiments, the present invention may readily utilize steps and sequences other than certain of those discussed in conjunction with the FIG. 7 embodiment.

In the FIG. 7 embodiment, in step 714, a verification threshold value “T” is initially defined in any effective manner. In step 718, verification module 218 (FIG. 2) then accesses distance measures 238 corresponding to candidates 416 of N-best list 412 (FIG. 4). In step 722, verification manager 218 utilizes the accessed distance measures 238 to calculate a verification measure “V”.

In step 726, verification module 218 determines whether verification measure “V” is less than verification threshold value “T”. If verification measure “V” is less than verification threshold value “T”, then in step 730, verification module 218 indicates that the matching category I 314(a) or category II 314(b) (FIG. 3) of the top candidate 416(a) of N-best list 412 is accepted in order to become a verified classification result 522. Conversely, if verification measure “V” is greater than or equal to the verification threshold value “T”, then verification module 218 indicates that the matching category I 314(a) or category II 314(b) (FIG. 3) of the top candidate 416(a) of N-best list 412 is rejected and the input text is considered unclassifiable. The FIG. 7 process may then terminate. The present invention advantageously provides distance measures 238 that are always positive values derived from the entire input space for input text 230. The distance measures 238 may be utilized to accurately classify various types of input text. For at least the foregoing reasons, the present invention therefore provides an improved system and method for utilizing distance measures 238 to perform text classification.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for performing text classification, comprising:
text classification categories that each include reference models of reference N-grams;
input text that includes input N-grams upon which said text classification is performed; and
a text classifier that calculates distance measures between said input N-grams and said reference N-grams, said text classifier utilizing said distance measures to identify a matching category for said input text.

2. The system of claim 1 wherein a verification module performs a verification procedure to determine whether said matching category is a valid classification result for said text classification.

3. The system of claim 1 wherein said distance measures quantify correlation characteristics between said input text and said reference models.

4. The system of claim 1 wherein each of said text classification categories corresponds to a different text classification subject.

5. The system of claim 1 wherein said text classifier calculates input statistics corresponding to said input N-grams, reference statistics corresponding to said reference models, and said distance measures by comparing said input statistics and said reference statistics.

6. The system of claim 1 wherein said input N-grams and said reference N-grams are configured as unigrams that each are formed of a single word.

7. The system of claim 1 wherein said input N-grams and said reference N-grams are configured as bi-grams that each are formed of a word pair.

8. The system of claim 1 wherein said input N-grams and said reference N-grams are configured as tri-grams that each are formed of a word triplet.

9. The system of claim 1 wherein said text classifier calculates input statistics corresponding to said input N-grams, each of said input statistics defining an observation frequency for one of said input N-grams in said input text.

10. The system of claim 9 wherein said input statistics are calculated with formulas:
$$P ( {w}_{i} ) = \frac{C ( {w}_{i} )}{{\sum }_{{w}_{i}} C ( {w}_{i} )} , \\ P ( {w}_{i} \vert {w}_{i - 1} ) = \frac{C ( {w}_{i - 1} {w}_{i} )}{{\sum }_{{w}_{i}} C ( {w}_{i - 1} {w}_{i} )} , \\ P ( {w}_{i} \vert {w}_{i - 2} {w}_{i - 1} ) = \frac{C ( {w}_{i - 2} {w}_{i - 1} {w}_{i} )}{{\sum }_{{w}_{i}} C ( {w}_{i - 2} {w}_{i - 1} {w}_{i} )}$$
where P(wᵢ) is a first frequency of single word unigrams, P(wᵢ|wi-1) is a second frequency of word-pair bigrams, P(wᵢ|wᵢ₋₂ wᵢ₋₁) is a third frequency of three-word trigrams, and C(wᵢ) is said observation frequency of a word wᵢ.

11. The system of claim 1 wherein said text classifier calculates reference statistics corresponding to said reference N-grams, each of said reference statistics defining an observation frequency for one of said reference N-grams in a corresponding reference database for one of said text classification categories.

12. The system of claim 9 wherein said reference statistics are calculated with formulas:
$$P ( {w}_{i} ) = \frac{C ( {w}_{i} )}{{\sum }_{{w}_{i}} C ( {w}_{i} )} , \\ P ( {w}_{i} \vert {w}_{i - 1} ) = \frac{C ( {w}_{i - 1} {w}_{i} )}{{\sum }_{{w}_{i}} C ( {w}_{i - 1} {w}_{i} )} , \\ P ( {w}_{i} \vert {w}_{i - 2} {w}_{i - 1} ) = \frac{C ( {w}_{i - 2} {w}_{i - 1} {w}_{i} )}{{\sum }_{{w}_{i}} C ( {w}_{i - 2} {w}_{i - 1} {w}_{i} )}$$
where P(wᵢ) is a first frequency of single word unigrams, P(wᵢ|wi-1) is a second frequency of word-pair bigrams, P(wᵢ|wᵢ₋₂ wᵢ₋₁) is a third frequency of three-word trigrams, and C(wᵢ) is said observation frequency of a word wᵢ.

13. The system of claim 1 wherein said distance measures are calculated with a formula:
$$D ( inp , tar ) = {\sum }_{Seq ( {w}_{i} ) ∈ input} ( {F}_{tar} ( {w}_{i} ) ln ( \frac{{F}_{tar} ( {w}_{i} )}{{F}_{inp} ( {w}_{i} )} ) + ( 1 - {F}_{tar} ( {w}_{i} ) ) ln ( \frac{1 - {F}_{tar} ( {w}_{i} )}{1 - {F}_{inp} ( {w}_{i} )} ) )$$
where D(inp, tar) is a current distance measure between a current input N-gram and a current reference model, said Fᵢₙₚ(wᵢ) being an N-gram probability statistic estimated from said input text, said Fₜₐᵣ(wᵢ) being an N-gram probability statistic estimated from said reference models.

14. The system of claim 1 wherein said text classifier generates an N-best list of classification candidates that are ranked according to said distance measures.

15. The system of claim 14 wherein a top candidate from said N-best list of classification candidates is a proposed text classification result for said text classification.

16. The system of claim 1 wherein a verification module accesses a pre-defined verification threshold value for performing a verification procedure for said matching category.

17. The system of claim 1 wherein a verification module accesses said distance measures to calculate a verification measure corresponding to said text classification.

18. The system of claim 17 wherein said verification measure is calculated with a formula:
Verification Measure=Distance A/Average Distance B
where Distance A is a best distance measure for a top classification candidate, and Average Distance B is an average distance measure from all remaining classification candidates.

19. The system of claim 17 wherein said verification manager compares said verification measure and a verification threshold value to confirm said matching category for said text classification.

20. The system of claim 19 wherein said matching category of the a hypothesis is accepted when said verification measure is less than said verification threshold, and wherein said matching category of said first hypothesis is rejected and said input text is not classified when said verification measure is greater than or equal to said verification threshold.

21. A method for performing text classification, comprising:
providing text classification categories that each include reference models of reference N-grams;
accessing input text that includes input N-grams upon which said text classification is performed;
calculating distance measures between said input N-grams and said reference N-grams; and
utilizing said distance measures to identify a matching category for said input text.

22. The method of claim 21 further comprising determining whether said matching category is a valid classification result for said text classification.

23. The method of claim 21 wherein said distance measures quantify correlation characteristics between said input text and said reference models.

24. The method of claim 21 wherein each of said text classification categories corresponds to a different text classification subject.

25. The method of claim 21 further comprising calculating input statistics corresponding to said input N-grams, calculating reference statistics corresponding to said reference models, and calculating said distance measures by comparing said input statistics and said reference statistics.

26. The method of claim 21 wherein said input N-grams and said reference N-grams are configured as unigrams that each are formed of a single word.

27. The method of claim 21 wherein said input N-grams and said reference N-grams are configured as bi-grams that each are formed of a word pair.

28. The method of claim 21 wherein said input N-grams and said reference N-grams are configured as tri-grams that each are formed of a word triplet.

29. The method of claim 21 further comprising calculating input statistics corresponding to said input N-grams, each of said input statistics defining an observation frequency for one of said input N-grams in said input text.

30. The method of claim 29 wherein said input statistics are calculated with formulas:
$$P ( {w}_{i} ) = \frac{C ( {w}_{i} )}{{\sum }_{{w}_{i}} C ( {w}_{i} )} , \\ P ( {w}_{i} \vert {w}_{i - 1} ) = \frac{C ( {w}_{i - 1} {w}_{i} )}{{\sum }_{{w}_{i}} C ( {w}_{i - 1} {w}_{i} )} , \\ P ( {w}_{i} \vert {w}_{i - 2} {w}_{i - 1} ) = \frac{C ( {w}_{i - 2} {w}_{i - 1} {w}_{i} )}{{\sum }_{{w}_{i}} C ( {w}_{i - 2} {w}_{i - 1} {w}_{i} )}$$
where P(wᵢ) is a first frequency of single word unigrams, P(wᵢ|wi-1) is a second frequency of word-pair bigrams, P(wᵢ|wᵢ₋₂ wᵢ₋₁) is a third frequency of three-word trigrams, and C(wᵢ) is said observation frequency of a word wᵢ.

31. The method of claim 21 wherein said text classifier calculates reference statistics corresponding to said reference N-grams, each of said reference statistics defining an observation frequency for one of said reference N-grams in a corresponding reference database for one of said text classification categories.

32. The method of claim 29 wherein said reference statistics are calculated with formulas:
$$P ( {w}_{i} ) = \frac{C ( {w}_{i} )}{{\sum }_{{w}_{i}} C ( {w}_{i} )} , \\ P ( {w}_{i} \vert {w}_{i - 1} ) = \frac{C ( {w}_{i - 1} {w}_{i} )}{{\sum }_{{w}_{i}} C ( {w}_{i - 1} {w}_{i} )} , \\ P ( {w}_{i} \vert {w}_{i - 2} {w}_{i - 1} ) = \frac{C ( {w}_{i - 2} {w}_{i - 1} {w}_{i} )}{{\sum }_{{w}_{i}} C ( {w}_{i - 2} {w}_{i - 1} {w}_{i} )}$$
where P(wᵢ) is a first frequency of single word unigrams, P(wᵢ|wi-1) is a second frequency of word-pair bigrams, P(wᵢ|wᵢ₋₂ wᵢ₋₁) is a third frequency of three-word trigrams, and C(wᵢ) is said observation frequency of a word wᵢ.

33. The method of claim 21 wherein said distance measures are calculated with a formula:
$$D ( inp , tar ) = {\sum }_{Seq ( {w}_{i} ) ∈ input} ( {F}_{tar} ( {w}_{i} ) ln ( \frac{{F}_{tar} ( {w}_{i} )}{{F}_{inp} ( {w}_{i} )} ) + ( 1 - {F}_{tar} ( {w}_{i} ) ) ln ( \frac{1 - {F}_{tar} ( {w}_{i} )}{1 - {F}_{inp} ( {w}_{i} )} ) )$$
where D(inp, tar) is a current distance measure between a current input N-gram and a current reference model, said Fᵢₙₚ(wᵢ) being an N-gram probability statistic estimated from said input text, said Fₜₐᵣ(wᵢ) being an N-gram probability statistic estimated from said reference models.

34. The method of claim 21 wherein said text classifier generates an N-best list of classification candidates that are ranked according to said distance measures.

35. The method of claim 34 wherein a top candidate from said N-best list of classification candidates is a proposed text classification result for said text classification.

36. The method of claim 21 further comprising accessing a pre-defined verification threshold value for performing a verification procedure for said matching category.

37. The method of claim 21 further comprising accessing said distance measures to calculate a verification measure corresponding to said text classification.

38. The method of claim 37 wherein said verification measure is calculated with a formula:
Verification Measure=Distance A/Average Distance B
where Distance A is a best distance measure for a top classification candidate, and Average Distance B is an average distance measure from all remaining classification candidates.

39. The method of claim 37 further comprising comparing said verification measure and a verification threshold value to confirm said matching category for said text classification.

40. The method of claim 39 wherein said matching category of the a hypothesis is accepted if said verification measure is less than said verification threshold, and wherein said matching category of said first hypothesis is rejected and said input text is not classified if said verification measure is larger than or equal to said verification threshold.

41. A system for performing text classification, comprising:
means for providing text classification categories that each include reference models of reference N-grams;
means for accessing input text that includes input N-grams upon which said text classification is performed;
means for calculating distance measures between said input N-grams and said reference N-grams; and
means for utilizing said distance measures to identify a matching category for said input text.
